(19) United States
(12) Patent Application Publication
(10) Pub. No.: US 2016/0230960 A1
(43) Pub. Date: Aug. 11, 2016

(54) Color conversion film and back light unit and display apparatus comprising the same

(71) Applicant: LG CHEM, LTD., Seoul (KR)

(72) Inventors: Joon Yeon SEO, Daejeon (KR); Byeong In Ahn, Daejeon (KR); Dong Mok Shin, Daejeon (KR); Nari Kim, Daejeon (KR); Kyung Yul Bae, Daejeon (KR); Ji Ho Kim, Daejeon (KR)

(21) Appl. No.: 15/014,556

(22) Filed: Feb. 3, 2016

(30) Foreign Application Priority Data
Feb. 6, 2015 (KR) 10-2015-0018937

(51) Int. Cl. F21V 9/16; G02B 1/14; G02B 1/04; F21V 33/00

(52) U.S. Cl. CPC F21V 9/16; F21V 33/0052; G02B 1/14; G02B 1/04

(57) ABSTRACT

The invention described in the present specification relates to a color conversion film including a color conversion layer including a resin matrix; and an organic fluorescent substance dispersed in the resin matrix, and absorbing blue or green light and emitting light having a wavelength different from the absorbing light; and a sticking sheet provided on at least one surface of the color conversion layer, and including a cured material of a radical curable component, a method for manufacturing the same, and a back light unit.

### TECHNICAL FIELD

The present application relates to a color conversion film, and a back light unit and a display apparatus including the same.

The present application claims priority to and the benefits of Korean Patent Application No. 10-2015-0018937, filed with the Korean Intellectual Property Office on Feb. 6, 2015, the entire contents of which are incorporated herein by reference.

### BACKGROUND ART

As large screen televisions become more common, televisions are also becoming high-definition, slimmer and highly functional. High performance and high definition OLED TVs still have problems of price competitiveness, and real markets for OLED TVs have not yet begun. Accordingly, efforts to similarly secure advantages of OLEDs with LCDs have been continuously made.

As one of the efforts, many quantum dot-related technologies and prototypes have been recently incorporated. However, cadmium-based quantum dots have safety problems such as restrictions on the use, and therefore, interests in manufacturing back lights using quantum dots without cadmium, which has relatively no safety issues, have been rising.

### DISCLOSURE

### Technical Problem

The present application provides a color conversion film introducing a sticking sheet that does not decline optical properties of the color conversion film including an organic fluorescent substance, and a back light unit and a display apparatus including the color conversion film.

### Technical Solution

One embodiment of the present application provides a color conversion film including a color conversion layer including a resin matrix; and an organic fluorescent substance dispersed in the resin matrix, and absorbing blue or green light and emitting light having a wavelength different from the absorbing light; and a sticking sheet provided on at least one surface of the color conversion layer, and including a cured material of a radical curable component.

Other embodiment of the present application provides a method for preparing a color conversion film including preparing a color conversion layer including a resin matrix; and an organic fluorescent substance dispersed in the resin matrix, and absorbing blue or green light and emitting light having a wavelength different from the absorbing light; and attaching a sticking sheet including a cured material of a radical curable component on at least one surface of the color conversion layer.

In the embodiment, the color conversion layer may be prepared using a method including coating a resin solution in which the organic fluorescent substance is dissolved on a substrate; and drying the resin solution coated on the substrate, or a method including extruding the organic fluorescent substance together with a resin.

Another embodiment of the present application provides a back light unit including the color conversion film.

Another embodiment of the present application provides a display apparatus including the back light unit.

### Advantageous Effects

According to the embodiments described in the present specification, by using a sheet-type radical curing sticking sheet cured prior to being attached to a color conversion layer as a sticking sheet adjoining at least one surface of a color conversion layer including an organic fluorescent substance, optical property decline of an organic fluorescent substance by UV curing of the radical curing sticking sheet. In other words, the present invention has expanded the scope of sticking and adhesive agents capable of being used in a color conversion layer including an organic fluorescent substance by finding materials that do not affect optical properties of an organic fluorescent substance among radical curing sticking and adhesive materials difficult to be directly used in a color conversion layer including an organic fluorescent substance, and preparing the criteria.

### DESCRIPTION OF DRAWINGS

FIG. 1 to FIG. 3 illustrate a laminated structure of a color conversion film according to embodiments of the present application.

FIG. 4 shows a mimetic diagram of a back light unit including a color conversion film according to one embodiment of the present application.

FIG. 5 is a mimetic diagram illustrating the structure of a display apparatus according to one embodiment of the present application.

### MODE FOR DISCLOSURE

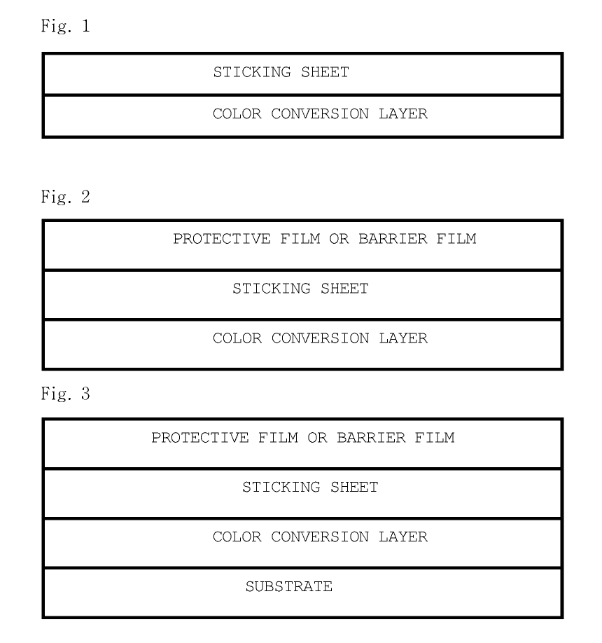

A color conversion film according to one embodiment of the present application includes a color conversion layer including a resin matrix; and an organic fluorescent substance dispersed in the resin matrix, and absorbing blue or green light and emitting light having a wavelength different from the absorbing light; and a sticking sheet provided on at least one surface of the color conversion layer, and including a cured material of a radical curable component. FIG. 1 shows a laminated structure of the color conversion film according to one embodiment of the present application.

In the present specification, the organic fluorescent substance may emit light when irradiating light having a light emission peak at 450 nm, a FWHM (full width at half maximum) of nm or less and monomodal light emission intensity distribution. Herein, the emitted light may be green light having a wavelength selected from wavelengths of 500 nm to 560 nm, red light having a wavelength selected from wavelengths of 600 nm to 780 nm, or a combination thereof.

In the present specification, the radical curing component includes a radical polymerizable compound cured through a radical polymerization reaction or components required for a radical polymerization reaction, for example, a radical initiator.

The radical polymerizable compound includes polyisocyanate having two or more isocyanate groups in the molecule, urethane acrylate reacting hydroxyalkyl (meth)acrylate, and the like, but is not limited thereto. As the radical initiator, those known in the art may be used.

Using a sticking layer or a sticking sheet when attaching a barrier film to a color conversion layer including an organic fluorescent substance or attaching other films thereto in order to flatten a curly film may directly affect the organic fluorescent substance due to the direct contact on the color conversion layer. Sticking or adhesive materials normally increase cohesiveness and adhesive strength through crosslinking, and methods of synthesizing radical polymers through ultraviolet curing are typically used. However, when using a radical curing adhesive material, a curing reaction that produces radicals occurs near an organic fluorescent substance when UV curing is carried out after coating a liquid sticking or adhesive agent in which a monomer and an initiator are mixed, and therefore, the organic fluorescent substance is very likely to be attacked.

However, the inventors of the present application have found out that, by attaching a sheet-type radical curing sticking sheet, which is cured prior to being attached to a color conversion layer, to a color conversion layer, optical property decline of an organic fluorescent substance caused by UV curing may be prevented.

The above sticking sheet that is capable of being attached after cured into the color conversion layer has the glass transition temperature of less than 0° C., preferably −10° C. to −100° C. The sticking sheet having the above range of glass transition temperature is readily attached into the color conversion layer after cured. A glass transition temperature can be measured by using DSC (Differential Scanning calorimeter) equipment.

Additionally, the sticking sheet that is capable of being attached after cured into the color conversion layer has 180° peel strength calculated by the following formula of 5% or more, preferably 30% or more, more preferably 50% or more:

(Peel strength after reattachment/Initial peel strength)*100(%) [Formula]

The sticking sheet according to one example may be a sticking sheet in a solid state formed through a curing process of an adhesive including a rubber-based adhesive resin and a radical initiator.

In the present specification, gel content of the sticking sheet including a cured material of a radical curable component is 50% or higher. The sticking sheet having gel content of 50% or higher may be formed by curing an adhesive having gel content of less than 30% including a radical curing component.

According to one embodiment, storage modulus of the sticking sheet including a cured material of a radical curable component measured at room temperature is 6.0×10⁵ dyne/cm² or higher.

A thickness of the sticking sheet including a cured material of a radical curable component may be determined as necessary, and for example, may vary from 10 micrometers to 50 micrometers.

According to another embodiment of the present application, a protective film or a barrier film may be attached on a surface of the sticking sheet facing a surface adjoining the color conversion layer in the embodiment described above. As the protective film and the barrier film, those known in the art may be used. FIG. 2 illustrates a laminated structure of a color conversion film provided with a protective film or a barrier film.

According to one embodiment, the color conversion film has a light emission wavelength with FWHM of 60 nm or less when irradiating light. The FWHM means a width of a light emission peak at a half of the maximum height in a maximum light emission peak of the light emitting from the film. The light emission peak's FWHM in the present specification may be measured in a film state. The light irradiated on the film when forming the FWHM may be light having a light emission peak at 450 nm, a FWHM of 40 nm or less and monomodal light emission intensity distribution. The light emission peak's FWHM may be determined from the types and the compositions of substances such as an organic fluorescent substance, a resin matrix or other additives included in the color conversion film. As the light emission peak's FWHM of the color conversion film becomes smaller, it is more advantageous in enhancing color gamut.

According to one embodiment of the present application, the organic fluorescent substance may include an organic fluorescent substance absorbing blue or green light and emitting red light, an organic fluorescent substance absorbing blue light and emitting green light, or a combination thereof.

In the present specification, blue light, green light and red light may use definitions known in the art, and for example, blue light is light having a wavelength selected from wavelengths of 400 nm to 500 nm, green light is light having a wavelength selected from wavelengths of 500 nm to 560 nm, and red light is light having a wavelength selected from wavelengths of 600 nm to 780 nm. In the present specification, a green fluorescent substance absorbs at least some of blue light and emits green light, and a red fluorescent substance absorbs at least some of blue light or green light and emits red light. For example, a red fluorescent substance may absorb light having a wavelength of 500 nm to 600 nm as well as blue light.

According to one embodiment of the present application, the organic fluorescent substance may use an organic fluorescent substance including a pyrromethene metal complex structure.

According to one example, an organic fluorescent substance of the following Chemical Formula 1 may be used as the organic fluorescent substance.

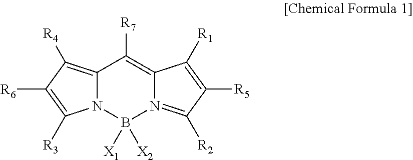

In Chemical Formula 1,

X₁ and X₂ are a fluorine group or an alkoxy group,

R₁ to R₄ are the same as or different from each other, and each independently hydrogen, a halogen group, an alkyl group, an alkoxy group, a carboxyl group-substituted alkyl group, an aryl group unsubstituted or substituted with an alkoxy group, —COOR or a —COOR-substituted alkyl group, and herein, R is an alkyl group,

R₅ and R₆ are the same as or different from each other, and each independently hydrogen, a cyano group, a nitro group, an alkyl group, a carboxyl group-substituted alkyl group, —SO₃Na, or an aryl group unsubstituted or substituted with arylalkynyl, and R₁ and R₅ are linked to each other to form a substituted or unsubstituted hydrocarbon ring or a substituted or unsubstituted heteroring, and R₄ and R₆ are linked to each other to form a substituted or unsubstituted hydrocarbon ring or a substituted or unsubstituted heteroring, and

R₇ is hydrogen; an alkyl group; a haloalkyl group; or an aryl group unsubstituted or substituted with a halogen group, an alkyl group, an alkoxy group, an aryl group or an alkylaryl group.

According to one embodiment, R₁ to R₄ of Chemical Formula are the same as or different from each other, and each independently hydrogen, a fluorine group, a chlorine group, an alkyl group having 1 to 6 carbon atoms, an alkoxy group having 1 to 6 carbon atoms, a carboxylic acid-substituted alkyl group having 1 to 6 carbon atoms, an aryl group having 6 to 20 carbon atoms unsubstituted or substituted with an alkoxy group having 1 to 6 carbon atoms, —COOR, or a —COOR-substituted alkyl group having 1 to 6 carbon atoms, and herein, R is an alkyl group having 1 to 6 carbon atoms.

According to another embodiment, R₁ to R₄ of Chemical Formula 1 are the same as or different from each other, and each independently hydrogen, a chlorine group, a methyl group, a carboxyl group-substituted ethyl group, a methoxy group, a phenyl group, a methoxy group-substituted phenyl group or a —COOR-substituted methyl group, and herein, R is an alkyl group having 1 to 6 carbon atoms.

According to one embodiment, R₅ and R₆ of Chemical Formula are the same as or different from each other, and each independently hydrogen, a nitro group, an alkyl group having 1 to 6 carbon atoms, a carboxyl group-substituted alkyl group having 1 to 6 carbon atoms, or —SO₃Na.

According to one embodiment, R₅ and R₆ of Chemical Formula are the same as or different from each other, and each independently hydrogen, a nitro group, an ethyl group, a carboxyl group-substituted ethyl group, or —SO₃Na.

According to one embodiment, R₇ of Chemical Formula 1 is hydrogen; an alkyl group having 1 to 6 carbon atoms; or an aryl group having 6 to 20 carbon atoms unsubstituted or substituted with an alkyl group having 1 to 6 carbon atoms, an alkoxy group having 1 to 6 carbon atoms, an aryl group having 6 to 20 carbon atoms or an alkylaryl group having 7 to 20 carbon atoms.

According to one embodiment, R₇ of Chemical Formula 1 is hydrogen, methyl, ethyl, propyl, butyl, pentyl, phenyl, methylphenyl, dimethylphenyl, trimethylphenyl, naphthyl, biphenyl-substituted naphthyl, dimethylfluorene-substituted naphthyl, terphenyl-substituted dimethylphenyl, methoxyphenyl or dimethoxyphenyl. According to one embodiment, Chemical Formula 1 may be represented by the following structural formulae.

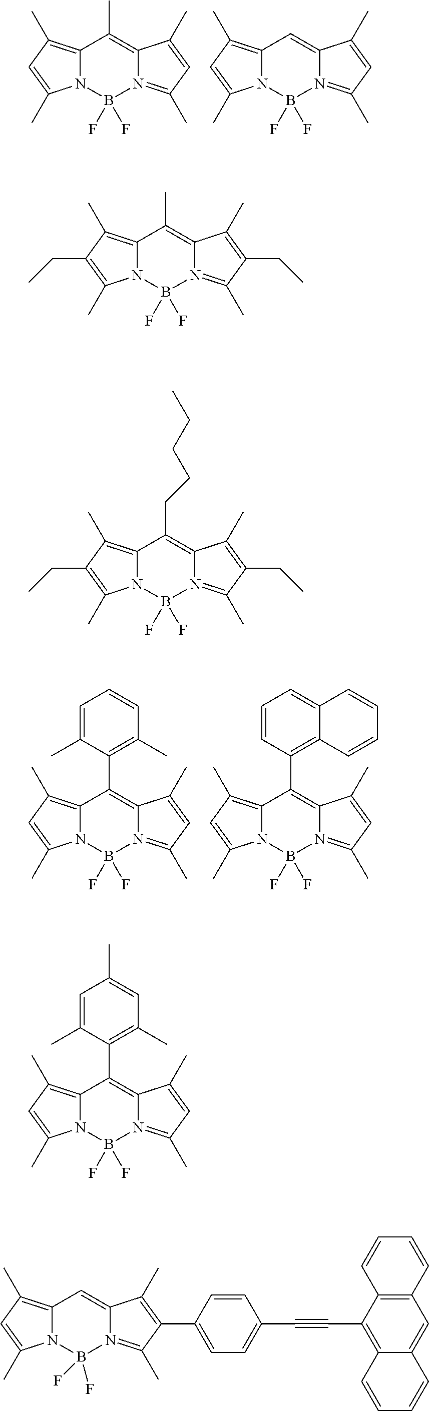

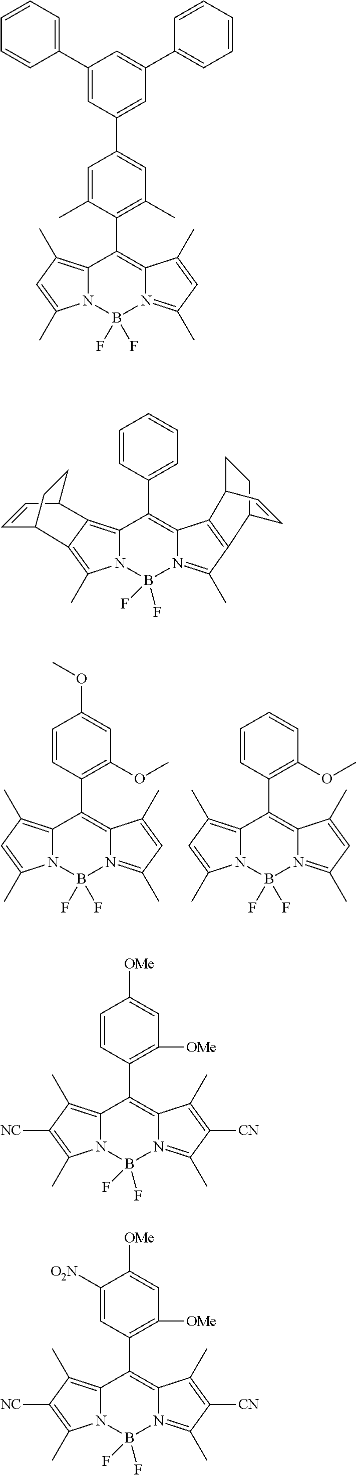

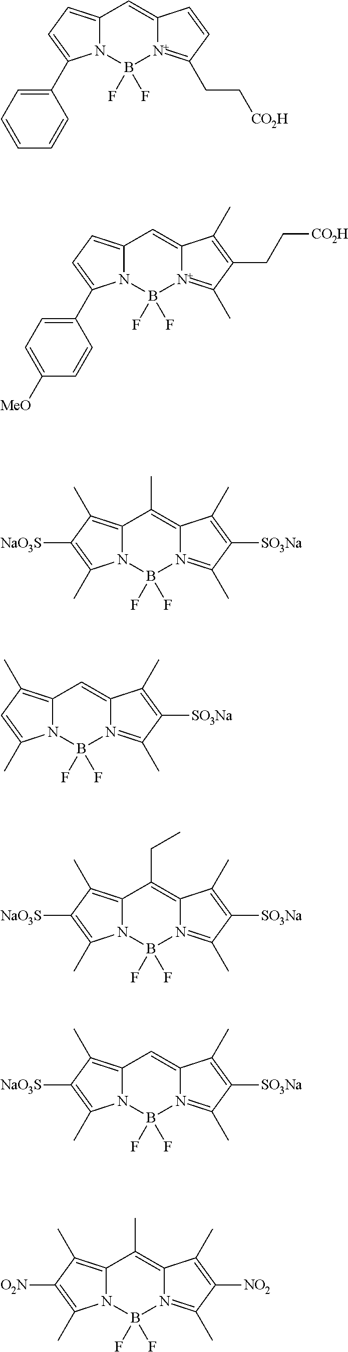

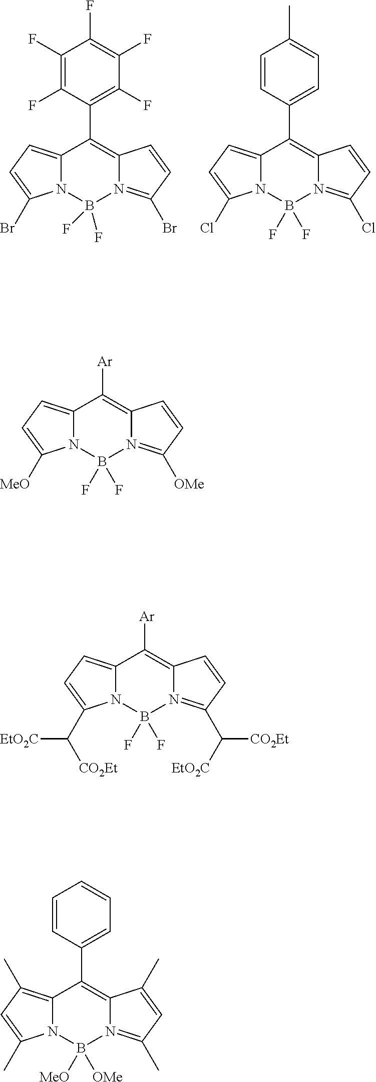

In the structural formulae, Ar is a substituted or unsubstituted aryl group. For example, Ar may be an aryl group substituted with an alkyl group or an alkoxy group.

For example, a compound having the following structural formula may be used. The compound having the following structural formula has a maximum absorption wavelength at 490 nm and a maximum light emission peak at 520 nm in a solution state.

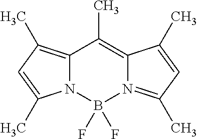

However, the compound is not limited to the above-mentioned structural formula, and various fluorescent substances may be used.

According to another example, a fluorescent substance having a maximum absorption wavelength at 560 nm to 620 nm and a light emission peak at 600 nm to 650 nm in a solution state may be used as the organic fluorescent substance. For example, compounds of the following Chemical Formula 2 may be used.

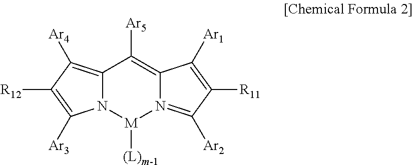

R₁₁, R₁₂ and L are the same as or different from each other, and each independently hydrogen, an alkyl group, a cycloalkyl group, an aralkyl group, an alkylaryl group, an alkenyl group, a cycloalkenyl group, an alkynyl group, a hydroxyl group, a mercapto group, an alkoxy group, an alkoxyaryl group, an alkylthio group, an arylether group, an arylthioether group, an aryl group, a haloaryl group, a heteroring group, halogen, a haloalkyl group, a haloalkenyl group, a haloalkynyl group, a cyano group, an aldehyde group, a carbonyl group, a carboxyl group, an ester group, a carbamoyl group, an amino group, a nitro group, a silyl group or a siloxanyl group, or may be linked to adjacent substituents to form a substituted or unsubstituted aromatic or aliphatic hydrocarbon or heteroring,

M is a metal having a valency of m, and includes boron, berylium, magnesium, chromium, iron, nickel, copper, zinc or platinum, and,

Ar₁ to Ar₅ are the same as or different from each other, and each independently hydrogen; an alkyl group; a haloalkyl group; an alkylaryl group; an amine group; an arylalkenyl group unsubstituted or substituted with an alkoxy group; or an aryl group unsubstituted or substituted with a hydroxyl group, an alkyl group or an alkoxy group.

According to one embodiment, Chemical Formula 2 may be represented by the following structural formulae.

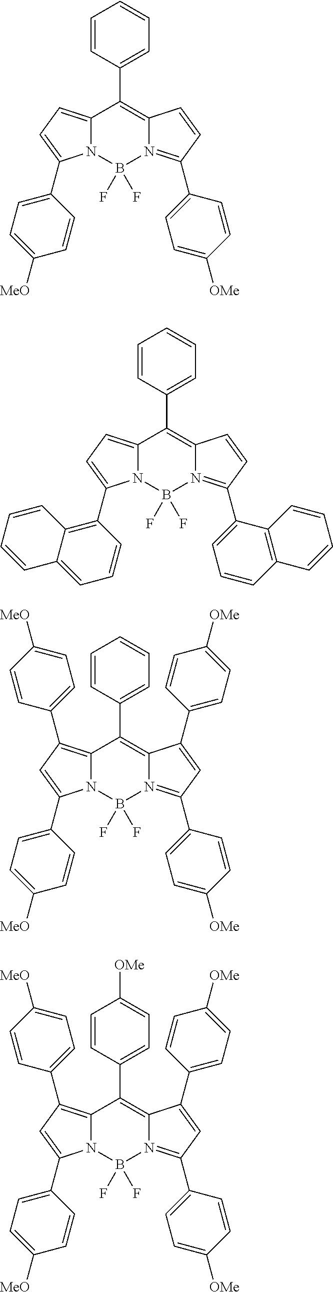

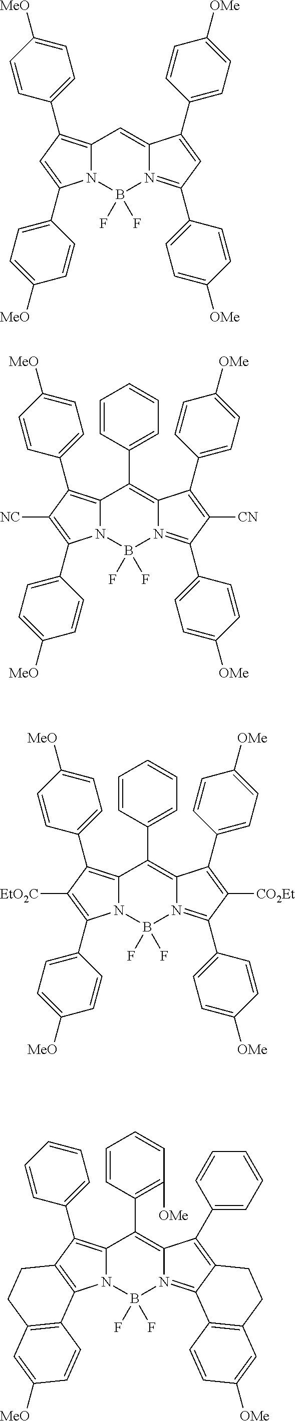

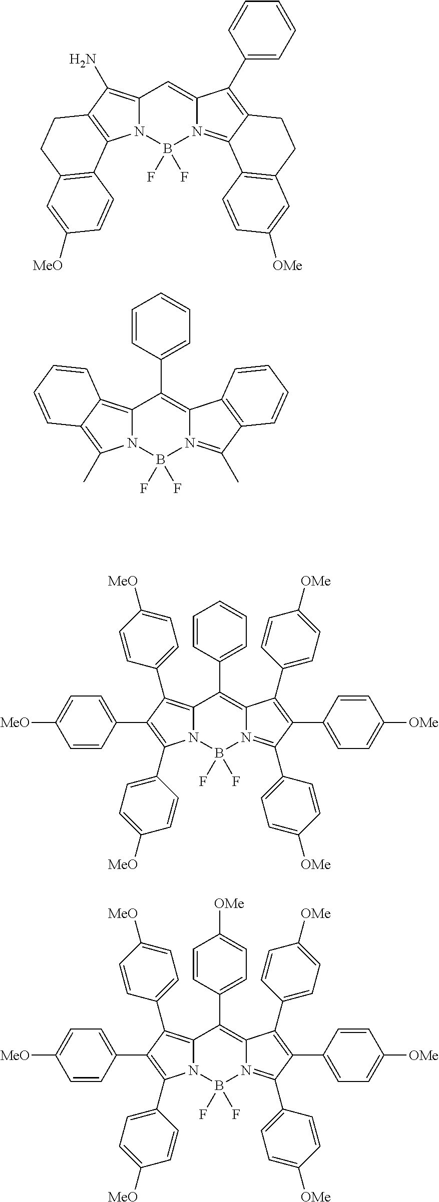

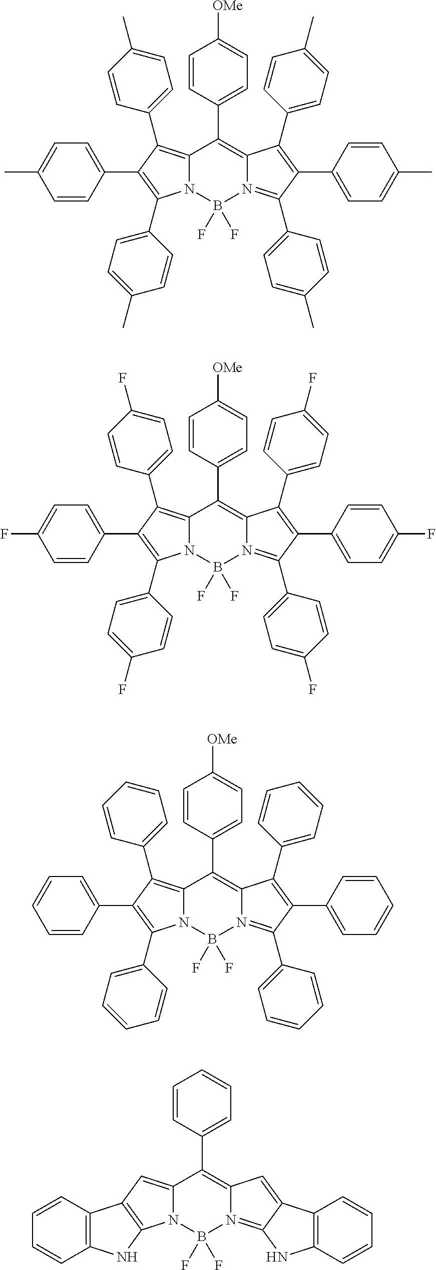

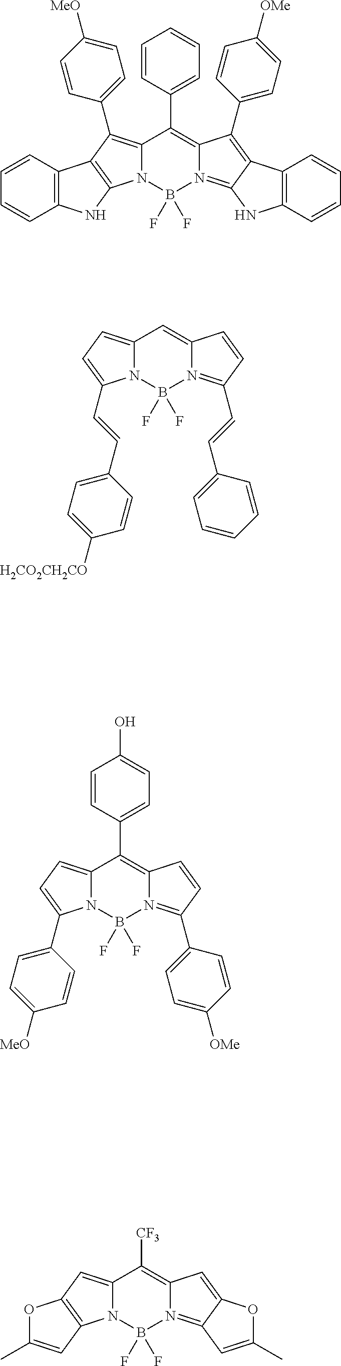

The fluorescent substance illustrated above has a light emission peak's FWHM of 40 nm or less in a solution state, and has a light emission peak's FWHM of approximately 50 nm in a film state.

The content of the organic fluorescent substance may be from 0.005 parts by weight to 2 parts by weight based on 100 parts by weight of the resin matrix.

The resin matrix material is preferably a thermoplastic polymer or a thermoset polymer. Specifically, a poly(meth)acryl-based such as polymethyl methacrylate (PMMA), a polycarbonate (PC)-based, a polystyrene (PS)-based, a polyarylene (PAR)-based, a polyurethane (TPU)-based, a styrene-acrylonitrile (SAN)-based, a polyvinylidene fluoride (PVDF)-based, a modified polyvinylidene fluoride (modified-PVDF)-based and the like may be used as the resin matrix material.

The color conversion layer according to the embodiments described above may have a thickness of 2 micrometers to 200 micrometers. Particularly, the color conversion layer may exhibit high brightness even with a small thickness of 2 micrometers to 20 micrometers. This is due to the fact that the content of the fluorescent substance molecules included in the unit volume is higher compared to quantum dots. For example, a 5 micrometer-thick color conversion film using the organic fluorescent substance content in 0.5 wt % is capable of showing high brightness of 4000 nit or higher under the brightness of 600 nit of a blue back light unit (blue BLU).

The color conversion film according to the embodiments described above may have a substrate provided on one surface. This substrate may function as a support when preparing the color conversion film. This substrate is provided on an opposite surface side of a surface of the color conversion layer facing the adhesive layer. Types of the substrate are not particularly limited, and the material or thickness is not limited as long as it is transparent and is capable of functioning as the support. Herein, transparent substrate means having visible light transmittance of 70% or higher. For example, a PET film may be used as the substrate. As necessary, the substrate may be replaced with a barrier film. FIG. 3 illustrates a laminated structure of a color conversion film provided with a substrate.

The color conversion layer may be prepared using a method including coating a resin solution in which the organic fluorescent substance is dissolved on a substrate; and drying the resin solution coated on the substrate, or a method including extruding the organic fluorescent substance together with a resin.

The organic fluorescent substance described above is dissolved in the resin solution, and therefore, the organic fluorescent substance is uniformly distributed in the solution. This is different from a quantum dot film preparation process that requires a separate dispersion process.

Additives may be added to the resin solution as necessary, and for example, light diffusing agent such as silica, titania, zirconia and alumina powder may be added. In addition, a dispersion agent may be further added in order for stable dispersion of the light diffused particles.

As for the resin solution in which the organic fluorescent substance is dissolved, the preparation method is not particularly limited as long as the organic fluorescent substance and the resin described above are dissolved in the solution.

According to one example, the resin solution in which the organic fluorescent substance is dissolved may be prepared using a method of preparing a first solution by dissolving an organic fluorescent substance in a solvent, preparing a second solution by dissolving a resin in a solvent, and mixing the first solution and the second solution. When mixing the first solution and the second solution, it is preferable that these be uniformly mixed. However, the method is not limited thereto, and a method of simultaneously adding and dissolving an organic fluorescent substance and a resin, a method of dissolving an organic fluorescent substance in a solvent and subsequently adding and dissolving a resin, a method of dissolving a resin in a solvent and then subsequently adding and dissolving an organic fluorescent substance, and the like, may be used.

The organic fluorescent substance included in the solution is the same as described above.

As the resin included in the solution, the resin matrix material described above, a monomer curable with this resin matrix resin, or a combination thereof, may be used. For example, the monomer curable with the resin matrix resin includes a (meth)acryl-based monomer, and this may be formed to a resin matrix material by UV curing. When using such a curable monomer, an initiator required for curing may be further added as necessary.

The solvent is not particularly limited as long as it is capable of being removed by drying afterword while having no adverse effects on the coating process. Non-limiting examples of the solvent may include toluene, xylene, acetone, chloroform, various alcohol-based solvents, methylethyl ketone (MEK), methylisobutyl ketone (MIBK), ethyl acetate (EA), butyl acetate, cyclohexanone, propylene glycol methylethyl acetate (PGMEA), dioxane, dimethylformamide (DMF), dimethylacetamide (DMAc), dimethyl sulfoxide (DMSO), N-methyl-pyrrolidone (NMP) and the like, and one type or a mixture of two or more types may be used. When the first solution and the second solution are used, solvents included in each of the solutions may be the same as or different from each other. Even when different types of solvents are used in the first solution and the second solution, these solvents preferably has compatibility so as to be mixed with each other.

The process of coating the resin solution in which the organic fluorescent substance is dissolved on a substrate may use a roll-to-roll process. For example, a process of unwinding a substrate from a substrate-wound roll, coating the resin solution in which the organic fluorescent substance is dissolved on one surface of the substrate, drying the result, and then winding the result again on the roll may be used. When a roll-to-roll process is used, viscosity of the resin solution is preferably determined in a range capable of carrying out the process, and for example, may be determined in a range of 200 cps to 2,000 cps.

As the coating method, various known methods may be used, and for example, a die coater may be used, or various bar coating methods such as a comma coater and a reverse comma coater may be used.

After the coating, a drying process is carried out. The drying process may be carried out under a condition required to remove a solvent. For example, a color conversion layer including a fluorescent substance having target thickness and concentration may be obtained on a substrate by carrying out the drying in an oven located close to a coater under a condition to sufficiently evaporate a solvent, in a direction of the substrate progressing during the coating process.

When a monomer curable with the resin matrix resin is used as the resin included in the solution, curing, for example, UV curing, may be carried out prior to or at the same time as the drying.

When the organic fluorescent substance is filmed by being extruded with a resin, extrusion methods known in the art may be used, and for example, a color conversion layer may be prepared by extruding the organic fluorescent substance with a resin such as a polycarbonate (PC)-based, a poly(meth)acryl-based and a styrene-acrylonitrile (SAN)-based.

Next, a process of attaching a sticking sheet including a cured material of a radical curable component on at least one surface of the color conversion layer may be carried out. The sticking sheet including a cured material of a radical curable component may be obtained by coating a composition including a radical curing component on a release film and then curing the result. The sticking sheet including a cured material of a radical curable component obtained as above is in a solid state, and therefore, has a glass transition temperature lower than room temperature and is flexible. The release film may be removed either prior to or after attaching the sticking sheet to a color conversion layer.

Another embodiment of the present application provides a back light unit including the color conversion film described above. The back light unit may have back light unit constitutions known in the art except for including the color conversion film. For example, FIG. 4 illustrates one example. According to FIG. 4, the color conversion film according to the embodiments described above is provided on a surface of a light guide plate opposite to a surface facing a reflecting plate. FIG. 4 illustrates a constitution including a light source and a reflecting plate surrounding the light source, however, the structure is not limited thereto, and may be modified depending on back light unit structures known in the art. In addition, the light source may use a direct type as well as a side chain type, and a reflecting plate or a reflecting layer may not be included or replaced with other constituents as necessary, and when necessary, additional films such as a light diffusion film, a light concentrating film and a brightness enhancement film may be further provided.

In the constitution of a back light unit such as in FIG. 4, a scattering pattern may be provided as necessary on an upper or lower surface of the light guide plate. Light flowed into the light guide plate has non-uniform light distribution caused by the repetition of optical processes such as reflection, total reflection, refraction and penetration, and the scattering pattern may be used for inducing the non-uniform light distribution to uniform brightness.

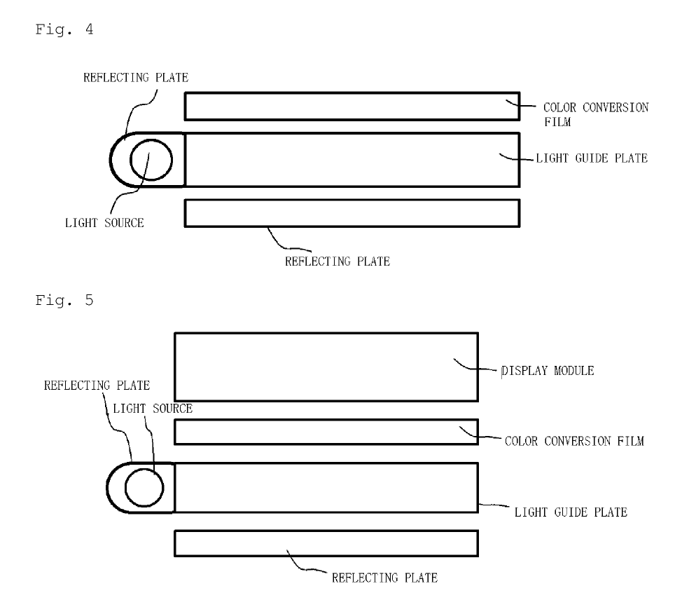

According to another embodiment of the present application, a display apparatus including the back light unit described above is provided. The display apparatus is not particularly limited as long as it includes the back light unit described above as a constituent. For example, the display apparatus includes a display module and a back light unit. FIG. 5 illustrates a structure of the display apparatus. However, the structure is not limited thereto, and additional films such as a light diffusion film, a light concentrating film and a brightness enhancement film may be further provided as necessary between the display module and the back light unit.

Hereinafter, the present invention will be described in more detail with reference to examples.

### Example 1

After separating a release film from a cured rubber-based sticking sheet, the sticking sheet was laminated on a color conversion layer including a resin matrix(SAN) and an organic fluorescent substance (organic fluorescent substance in 0.2 parts by weight based on 100 parts by weight of the resin), and a PET film was attached thereon. The glass transition temperature of the cured rubber-based sticking sheet was measured as −50° C. by using DSC (Differential Scanning calorimeter) equipment.

With a color conversion film prepared as above, changes with the passage of time was observed under an N₂ atmosphere condition, a 60° C. driving condition (condition irradiating light emitting from a blue LED back light having a maximum light emission wavelength in a 440 nm to 460 nm range on the whole color conversion film using a light guide plate at 60° C.), a 60° C./90% relative humidity, and a 80° C. high temperature condition, and the color conversion film maintained brightness at 95% or higher compared to initial brightness for 500 hours or longer. The test results are shown in the following Table 1.

### Comparative Example 1

Preparation was carried out in the same manner as in Example 1 except that, instead of the sticking sheet, an adhesive solution mixing hydroxyl ethyl acrylate (HEA) (including monomethyl ether hydroquinone of approximately 200 ppm to 650 ppm as an inhibitor in addition to pure HEA), which is a radical polymerizable monomer, and a photo initiator in 3% by weight was applied on a color conversion layer, a PET film was attached thereon, and the result was cured by UV irradiation. The test results are shown in the following Table 1. After separating the cured results, the glass transition temperature was measured as 8° C. by using DSC (Differential Scanning calorimeter) equipment.

Changes with the passage of time under the same condition as in Example 1 was observed, and it was identified that brightness greatly decreased.

TABLE 1

| | N₂ | 60° C. Driving | 60° C./90% RH | 80° C. |
|---|---|---|---|---|
| Example 1 | 99% | 100% | 99% | 98% |
| Comparative | 95% | 65% | 94% | 90% |
| Example 1 | | | | |

Samples prepared by the above Example 1 and Comparative Example 1 were cut so as to have the width of 1 cm, and then initial peel strength was measured by peeling at 180° direction at the rate of 10 mm/min. Then, the two peeled surfaces was laminated into each other again (reattachment) and peel strength was measured in the same manner as the above. The ratio of peel strength after reattachment to initial peel strength was calculated as 69% of Example 1 and 0% of Comparative Example 1.

1. A color conversion film comprising:
a color conversion layer including a resin matrix; and an organic fluorescent substance dispersed in the resin matrix, and absorbing blue or green light and emitting light having a wavelength different from the absorbing light; and
a sticking sheet provided on at least one surface of the color conversion layer, and including a cured material of a radical curable component.

2. The color conversion film of claim 1, wherein the sticking sheet has the glass transition temperature of less than 0° C.

3. The color conversion film of claim 1, wherein the sticking sheet has the ratio of 180° peel strength after reattachment to initial 180° peel strength of 5% or more.

4. The color conversion film of claim 1, further comprising a substrate provided on a surface of the color conversion layer opposite to a surface facing the sticking sheet.

5. The color conversion film of claim 1, further comprising a protective film or a barrier film provided on a surface of the sticking sheet facing a surface adjoining the color conversion layer.

6. The color conversion film of claim 1, which has a light emission peak's FWHM of 60 nm or less when irradiating light having a light emission peak at 450 nm, a FWHM of 40 nm or less and monomodal light emission intensity distribution.

7. A method for preparing the color conversion film of claim 1, the method comprising:
preparing a color conversion layer including a resin matrix; and an organic fluorescent substance dispersed in the resin matrix, and absorbing blue or green light and emitting light having a wavelength different from the absorbing light; and
attaching a sticking sheet including a cured material of a radical curable component on at least one surface of the color conversion layer.

8. The method for preparing the color conversion film of claim 7, wherein the preparing of a color conversion layer is carried out using a method including coating a resin solution in which the organic fluorescent substance is dissolved on a substrate; and drying the resin solution coated on the substrate, or a method including extruding the organic fluorescent substance together with a resin.

9. A back light unit comprising the color conversion film of claim 6.

10. A display apparatus comprising the back light unit of claim 9.
